(19) United States
(12) Patent Application Publication
(10) Pub. No.: US 2017/0127663 A1
(43) Pub. Date: May 11, 2017

(54) SYSTEM AND METHOD FOR ERADICATING BURROWING RODENTS USING ENGINE EXHAUST GAS

(71) Applicant: AERO CAMINO INDUSTRIAL LLC, GOLETA, CA (US)

(72) Inventor: FRANK J. BOURBEAU, SANTA BARBARA, CA (US)

(73) Assignee: AERO CAMINO INDUSTRIAL LLC

(21) Appl. No.: 14/933,959

(22) Filed: Nov. 5, 2015

(51) Int. Cl. A01M 13/00; A01M 99/00; F01N 13/08; F28D 21/00; F02B 75/02; F01N 3/02; A01M 17/00; A01M 25/00

(52) U.S. Cl. CPC A01M 13/006; A01M 17/004; A01M 99/00; A01M 25/006; F28D 21/0003; F02B 75/02; F01N 3/0205; F01N 13/08; A01M 2200/00; F02B 2075/027

(57) ABSTRACT

A system and method for eradicating burrowing rodents uses an internal combustion engine running at high speed and zero mechanical load to convert gasoline and air into pressurized carbon monoxide entrained in an inert gas mixture consisting mostly of nitrogen and water vapor. A heat exchanger cools the exhaust gas and provides it to one or more outputs. Respective hoses are coupled to the outputs, with each hose coupled to an injector tube adapted for insertion into a subterranean tunnel in which a rodent may be present. The engine is preferably mounted on a wheeled tubular frame which may be part of a hand truck or a trailer frame, with the frame serving as both structural member and as heat exchanger. The system pumps gas into the tunnel, replacing the existing atmosphere with oxygen poor, CO rich gas that causes the rodents to succumb to a combination of CO poisoning and hypoxia.

### BACKGROUND OF THE INVENTION

Field of the Invention

This invention relates to systems and methods for eliminating burrowing rodents, particularly gophers of the genus Thomomys and ground squirrels of the genus Spermophilus, within their subterranean tunnels.

Description of the Related Art

Burrowing rodents are a major cause of damage to agricultural crops, commercial and homeowner landscaping, community parks and sports field, etc. As such, many methods have been developed to rid a property of such rodents. In addition to underground traps and poison baits, some methods attempt to kill the rodent with engine exhaust gas.

For example, agriculturists have for years used the exhaust gas from farm equipment to fumigate rodent tunnels. More recently, manufacturers have offered kits consisting of exhaust pipe connectors and hoses that facilitate using automobile exhaust gas for tunnel fumigation. For example, U.S. Pat. No. 5,700,039 describes a device that facilitates the connection of a hose to an automobile exhaust pipe. However, using the exhaust gas from a modern auto or truck engine for rodent control risks expensive damage to the vehicle's catalytic converter and engine. In addition, the vehicle's catalytic converter removes virtually all of the carbon monoxide (CO) and oxygen (O₂) from the exhaust stream. Such purified exhaust gas is able to kill rodents only by lack of oxygen (hypoxia).

Another such system is disclosed in U.S. Pat. No. 7,581,349. It is designated by the manufacturer as the PERC™ (Pressurized Exhaust Rodent Control). This system employs an internal combustion engine that drives a conventional piston type compressor that compresses the engine exhaust gas after it exits the engine's exhaust port. The engine exhaust is cooled by a gas-to-air heat exchanger and fed into the compressor intake. The cooled and compressed exhaust gas then flows into a pressure vessel. Two or more hoses are connected to the pressure vessel. The output ends of the hoses are terminated with metal tubes which are inserted into the rodent tunnels. The exhaust floods the tunnels with gas containing about 84% nitrogen, about 14% carbon dioxide, 1% trace compounds, a low percentage of carbon monoxide and high percentage of oxygen.

The reason for the PERC's low carbon monoxide production centers on a tee pipe fitting described in U.S. Pat. No. 7,581,349. The tee's middle opening accepts the engine exhaust gas as it exits the muffler. The tee's upper opening directs a portion (about 50%) of the exhaust gas to the gas-to-air heat exchanger placed between the tee and the compressor intake. The tee's lower end is open to the atmosphere. During the engine's exhaust stroke, about half of the exhaust gas flows from the muffler through the tee's upper opening to the compressor intake via the heat exchanger. The remaining portion of the exhaust gas vents from the tee's lower opening directly to the surrounding air. The engine's exhaust valve is closed for the three piston strokes (intake, compression and power) following the exhaust stroke. This causes the compressor's intake to be connected via the tee fitting to the surrounding air when the engine's exhaust valve is closed during these three piston strokes. During this time, fresh air flows into the compressor intake through the open end of the tee when one of the compressor's two pistons is on its suction stroke. This air dilutes the engine exhaust gas, reducing the carbon monoxide content from the typical 2% value for an engine driving its rated load to about 1%. At the same time, dilution with ambient air increases the oxygen content of the exhaust gas from a fractional percentage to about 16%.

A major limitation of fumigating rodent tunnels with exhaust gas that has been compressed after exiting the engine is that the mechanical load on the engine produced by the compressor reduces the exhaust gas CO content to the typical 2% concentration cited above. This makes the exhaust gas less lethal compared to what it would be if the gas was injected into the burrow directly from the exhaust pipe of an unloaded engine. Three other limitations that arise from using a compressor to pressurize the engine's exhaust are: 1) high cost because, unlike small engines, compressors are not mass-produced, 2) high maintenance cost associated with compressing dirty water-laden gas, 3) size and weight eliminate the possibility of operating a compact lightweight hand-pulled machine in heavily landscaped areas and 4) air must be allowed to bleed into the compressor inlet in order to allow the compressor to draw in air when the engine's exhaust valves is closed. This valve is closed for three out of the four strokes of the 4-stroke engine.

### SUMMARY OF THE INVENTION

A system and method for eradicating burrowing rodents are presented which address some of the problems noted above by providing a means of killing burrowing rodents within their tunnels without requiring a separate compressor, heat exchanger or pressure vessel.

The present eradication system for burrowing rodents utilizes an engine which produces hot pulsating (one pulse per two revolutions for a single cylinder engine) pressurized exhaust gas from the engine's exhaust port; the system preferably includes a muffler to attenuate the sound level and reduce the exhaust gas temperature and a gas-to-air heat exchanger to further cool the gas so as to provide cool pressurized gas to gas distribution hoses. The input ends of one or more hoses are coupled to the heat exchanger output, and the other ends of the hoses are connected to injector tubes.

The injector tubes are inserted into the rodent tunnels, preferably via small diameter pilot holes previously made by metal probes. Cooled gas is pumped into the tunnel when the engine is running, filling it with a mixture that is rich in carbon monoxide and low in oxygen. The lethal combination of poison and hypoxia causes the rodents within the tunnel to quickly succumb.

The engine speed governor is preferably removed in the process of converting the engine to be a toxic gas generator. This permits higher engine speed which results in an increased gas production rate. Operating without a governor makes the engine speed dependent on exhaust back pressure. This allows the operator to detect a plugged tunnel by recognizing the change in pitch of the engine sound as speed decreases in response to the increased load caused by increased back pressure from a plugged tunnel. Alternatively, an electronic interface can be connected between the low voltage magneto coil and a sound transducer to create an audible tone with a frequency proportional to engine speed.

Automotive exhaust gas analyzer testing showed a CO content between 8.5% and 8.9% for 212 cc and 420 cc engines operating as gas generators at high speed with no mechanical load. This high CO content is the result of the incomplete combustion of the rich fuel-air mixture caused by operating at high engine speed and zero mechanical load. The ignition timing for an engine conventionally designed to drive a mechanical load is set to produce the ignition spark in advance of the piston reaching top dead center; this improves power and efficiency and reduces the exhaust gas CO content by compensating for the time lag of the combustion process. For an engine operated for the sole purpose of producing poison gas, the spark may be retarded to ignite the fuel-air after the piston reaches top-dead-center. This has the effect of decreasing power and efficiency while increasing exhaust gas CO content.

A decrease in speed will result from the power loss caused by retarding the spark. However, speed can be restored to its normal high value (typically 3000 rpm) by increasing the carburetor throttle opening. Opening the throttle increases the both intake air flow rate and the exhaust gas output flow rate. The increased exhaust flow rate is beneficial in two ways: the total amount of CO injected into the tunnel is increased thus improving its toxicity, and the velocity of the gas traveling through the tunnel is increased thus reducing the probability that the rodent will be able outrun the gas cloud before it succumbs.

A small lightweight engine of about 200 cc displacement is capable of supplying gas to two hoses. The engine, which may have a horizontally- or vertically-oriented drive shaft, is suitably mounted over the wheels of man-pulled hand truck for easy transport through landscaped areas. The hand truck frame is preferably comprised of side, front and rear steel tubes that both conduct and cool the exhaust gas as it passes from the engine's muffler to a pair of output fittings such as brass male garden hose bibs.

For large agricultural applications such as vineyards, a trailer-mounted engine of 400 to 600 cc displacement supplies lethal gas to up to four hoses. The trailer frame and tongue are made from bent or welded square or round steel tubing. The engine exhaust follows a path from the muffler to the trailer tongue, then to a front frame tube, then to the frame side tubes, then to the rear frame tube and finally to the hose bibs. The hoses and injector tubes may be the same as those used with the 200 cc machine.

The hoses, preferably made from oil resistant Nitrile or similar synthetic rubber, are preferably fitted with easily disconnected corrosion resistant brass garden hose couplings. The gas injector tubes are preferably made from brass tubing fitted with brass garden hose fittings on the gas input end. Slots milled into the tube near the output end allow gas to exit the tube and enter the tunnel. A pointed metal plug is attached to the tube output end to prevent dirt ingress and to allow for easy penetration into the earth above the rodent tunnel via a pilot hole previously made by a tunnel probe.

During operation, water produced by the combustion process collects in the tubing that comprises the heat exchanger and vehicle frame tubing. To prevent rust damage or blocking of the gas flow by a large amount of water, a small bleed hole is preferably made at the low point of the frame to allow a small amount of pressurized gas to expel the water.

Further features and advantages of the invention will be apparent to those skilled in the art from the following detailed description, taken together with the accompanying drawings.

### BRIEF DESCRIPTION OF THE DRAWINGS

FIG. 1 is a perspective view of a 212 cc hand-pulled truck embodiment of a burrowing rodent eradication system per the present invention.

FIG. 2 depicts a gas hose that may be used with various sizes of rodent eradication machines.

FIG. 3 depicts one embodiment of a gas injector tube used with the present invention.

FIG. 4 depicts one embodiment of a tunnel probe used with the present invention.

FIGS. 5a and 5b illustrate how the magneto can be re-positioned to retard ignition timing for operation at zero mechanical power and high CO production.

FIG. 6 is a perspective front view of a 420 cc vehicle-pulled trailer embodiment of a burrowing rodent eradication system per the present invention.

FIG. 7 is a perspective view of a hose rack at the rear of the present invention.

FIG. 8 is a perspective view of a hose reel at the rear of the present invention.

FIGS. 9a-9d show how hose is deployed and retrieved using a proprietary hose reel.

FIG. 10 is a transcription of a typical printout from an automotive emissions tester.

### DETAILED DESCRIPTION OF THE INVENTION

The description of the present system proceeds from a review of the Otto thermodynamic cycle on which it is based to a description of a small hand-pulled rodent eradication system that is suitable for treating a limited-size homeowner's property, then to a description of an All Terrain Vehicle (ATV)-towed machine that is capable of controlling burrowing rodents in vineyards, alfalfa farms, potato farms and other large irrigated agricultural operations. One or more embodiments of the present rodent eradication system are identified with the brand name Gophex™.

The engine operates on the Otto thermodynamic cycle. For a one-cylinder engine serving as an inert gas generator—i.e., with only friction and flywheel torque, with no mechanical power applied to a load such as a mower blade—the cycle is described as:

Induction Stroke—rotational energy stored in the crankshaft and flywheel is converted to linear energy to pull the piston down against friction primarily caused by sliding contact of the piston rings and cylinder wall. Downward motion of a piston creates a vacuum that draws a mixture of fuel and air into the cylinder through an open intake valve with the exhaust valve closed;

Compression Stroke—upward motion of the piston with both valves closed compresses and heats the fuel-air mixture. The energy absorbed in moving the piston against friction and heating the air-fuel mixture is again taken from the rotational energy of the flywheel;

Power Stroke—a spark ignites the fuel air mixture when the piston is near top dead center. The burning and expanding mixture creates a downward force on the piston which is converted to torque by the connecting rod and crankshaft. This torque increases the speed of the crankshaft and flywheel, adding rotational energy that will be extracted during the exhaust, intake and compression strokes;

Exhaust Stroke—with the exhaust valve open, rotational energy is depleted in the process of moving the piston upward against piston/cylinder friction and the back pressure in the combustion chamber caused by restrictions in the path of the exhaust gas flow.

Stored Mechanical Energy—As noted above, the engine crankshaft and flywheel store energy as the speed of the rotating mass increases during the power stroke, and releases that energy during the three strokes that follow the power stroke. This process is accompanied by an increase in the instantaneous speed during the power stroke and a decrease in the instantaneous speed during the following three strokes.

As an example of how a typical system would perform, assume an eradication system based on a single cylinder 200 cc engine, which may have a horizontally or vertically oriented drive shaft; this size engine would be light enough to be mounted on a 2-wheel hand truck and is capable of supplying gas to two hoses. At 3000 rpm, the engine will produce 25 exhaust gas pulses per second. The average volumetric gas flow rate will be approximately 25*200=5000 cm³/sec (5.0 l/s). A typical gopher tunnel has a diameter of 5 cm, equivalent to an area of about 20 cm². The average linear flow rate will be 5000/20=250 cm/s or 2.5 m/s. Because of non-ideal engine valve operation, the actual flow rate will be closer to 2 m/s. This is equivalent to about 4.5 mph, or about twice the normal human walking speed. As such, it is doubtful that a gopher would be able to run fast enough to escape immersion in the toxic gas.

The gas flow rate decreases as the gas is absorbed by permeable soil. This establishes an effective killing radius that is a function of soil permeability.

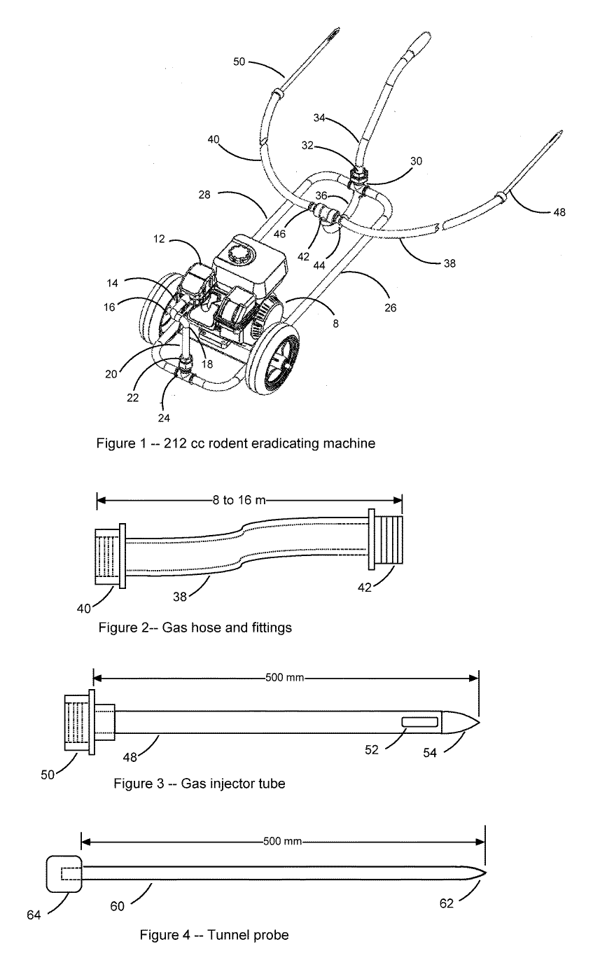

An eradication system as described herein may be mounted on any sort of structure capable of supporting the engine; the structure may include wheels to provide easy mobility, though this is not essential. One possible embodiment is shown in FIG. 1 where an engine 8 of typically 200 cc displacement is mounted over the wheels 9 and 10 of a hand truck. An engine of this size can supply adequate gas to one 100 ft. long ⅝ in. inside diameter tube or two 50 ft. long hoses with the same ID.

The hot exhaust gas from the engine 8 exits the muffler 12 via an outlet pipe fitting 14 into two street ell pipe fittings 16 and 18. Exhaust gas then flows down through a pipe 20 and a union 22. The union provides a means of removing the engine from the system with minimum disturbance to the piping.

An inlet tee fitting 24 splits the gas into two paths through hand-truck side tubes 26 and 28. The muffler, piping and the hand truck's frame serve as the required gas-to-air heat exchanger, cooling the exhaust gas to a safe temperature and reducing the engine sound level as it flows from the engine exhaust to the outlet hose fittings.

The top outlet of a cross fitting 30 is plugged and attached to a union 32 which allows the hand truck's handle 34 to be removed to facilitate storage and transportation.

A u-shaped tube 36 serves as a skid to keep the hand truck reasonably level when the engine is running. It also conveys cooled exhaust gas to hoses 38 and 40 via a tee 42 and male hose bibs 44 and 46. Removable gas injector tubes 48 and 50 are attached to the hose ends.

FIG. 2 details a hose assembly 38 as might be attached to the hose bib(s) of the small burrowing rodent eradicating machine shown in FIG. 1 or to the hose bibs of higher displacement machines having more or longer hoses. The hose material is preferably fiberglass-reinforced oil-resistant flexible synthetic rubber generically described as nitrile. The hose inside diameter is typically ⅝ in. The receiving and outlet hose ends are preferably fitted with a female hose fitting 41 and a male hose fitting 43, respectively. The hose fitting material is typically brass.

FIG. 3 details a typical gas injector tube assembly 48. The inlet end is fitted with a female hose fitting 50 which is welded, braised or soldered to the injector tube 46. Two or more slots 52 are milled into the tube all at the outlet end to allow gas to flow into the tunnel. The tube end is terminated with a bullet shaped metal plug 54.

The present system preferably further includes a tunnel probe, an example of which is shown in FIG. 4, for locating a subterranean tunnel in which burrowing rodents might be present. Such a probe would preferably comprise a rod 60 made from carbon steel, stainless steel, brass or aluminum, with a pointed end 62 and a wooden or plastic block 64 on the other end to facilitate the application of downward force to the rod. The rod diameter is preferably less than that of gas injector tube 48, so that the tunnel probe makes a pilot hole for the injector tube.

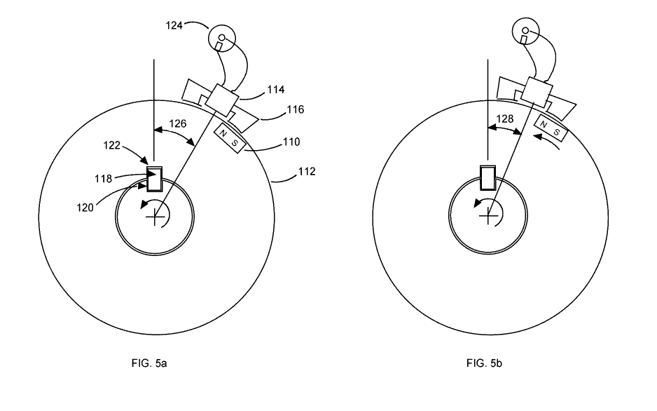

The CO concentration can be increased by retarding the ignition timing angle. This can be accomplished by re-positioning the magneto in the direction of crankshaft rotation. A typical ignition system for small engines is shown in FIG. 5a. It consists of a permanent magnet 110 that is embedded in flywheel 112 and a stationary magneto coil 114 and laminated core 116 that is fixed to the engine crankcase. The angular position of the magnet with respect to the crankshaft is fixed by a crankshaft key 118 which fills the crankshaft slot 120 and the flywheel slot 122. The gap between the core and the flywheel is typically about 0.50 mm. As the flywheel rotates, it creates flux changes when the north and south poles of the magnet sweep past the steel core. These flux changes induce high voltage pulses that ionize the air in the vicinity of the spark plug electrodes 124. The resulting spark ignites the air-fuel mixture in the cylinder.

FIG. 5a shows the magneto core 114 and coil 116 positioned against the direction of rotation at a typical spark advance angle 126 of 30° ahead of the vertical line that defines the crankshaft angle corresponding to the piston's top-dead-center position. FIG. 5b shows the magneto re-positioned in the direction of crankshaft rotation by 10° to reduce the spark advance angle 128 from the normal 30° to 20°. The 10° reduction in the spark timing delay angle, plus the inherent combustion delay, causes the fuel-air mixture to ignite well after the piston has begun its downward power stroke descent. The result is a large quantity of unburned hydrocarbons containing a high percentage of CO. The percentage of CO, as determined by a California certified motor vehicle emissions test machine, was measured at 8.6% with normal advanced ignition timing. Reducing the timing advance angle from 30° to 20° as shown in FIG. 5b should put the CO level to well over 10%-about ten times the CO level of commercially available rodent gassing machines.

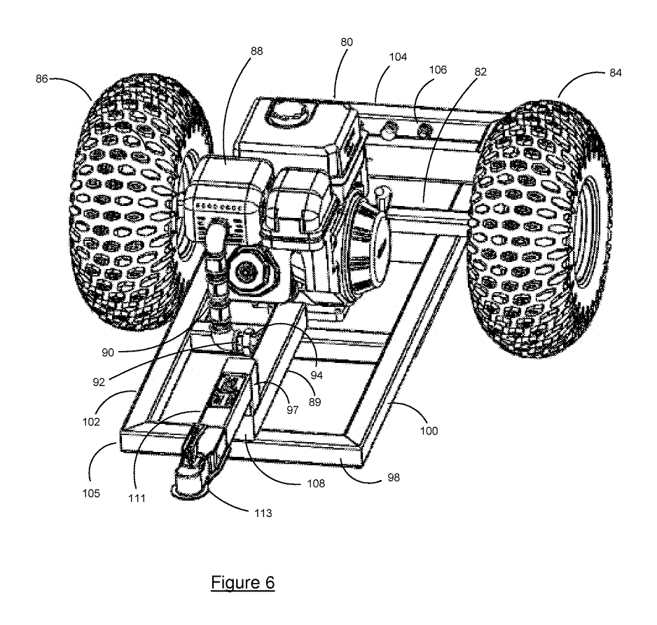

A second possible embodiment of a trailer mounted version of the present system, suitable for use on large properties, is shown in the perspective view of FIG. 6 (note that the small engine embodiment of FIG. 1 and the larger embodiment of FIG. 6 are similar, though not identical). The system includes an engine 80, with a preferable displacement of 400-600 cc, mounted above an axle 82 coupled to wheels 84 and 86. The engine emits exhaust gas from a muffler 88 that serves to attenuate engine noise and partially cool the exhaust gas. The gas from the muffler outlet is preferably passed over and down to a trailer tongue section 89 through an exhaust pipe assembly 90 comprised of tapered pipe thread ells, couplings, nipples and a union 92. The union attaches to a pipe bung 94 which is welded to a hole in the side of a portion of tongue section 89. The tapered pipe threads of the exhaust pipe assembly permit adjustment of the muffler height with respect to the engine mounting plate. The dis-connectable union permits the engine to be removed from the trailer.

The distributed heat exchanger is comprised of the exhaust pipe assembly 90, tongue section 89, trailer frame front tube 98, side tubes 100 and 102 and rear frame tube 104. The trailer frame corners 105 are preferably 45° miter cut and welded. A 1.0 in. diameter hole is preferably centered at the underside of the front frame tube and placed over a matching hole in the top of trailer tongue section 89. This tongue section is welded to the front frame tube 98 to make a sealed gas passage through the 1.0 in. diameter hole in the tongue section 89 to a matching hole in the front frame tube 98. A metal plate 108 welded to the end of tongue tube section 89 prevents gas flow out of the tube end. After flowing into the front frame tube, the gas temperature drops as the gas loses heat to the metal tubing as it divides and flows through the side tubes 100 and 102 and the rear tube 104 to hose fittings 106 attached to the rear tube. The hose fitting temperature is typically about 20° C. above the ambient temperature.

A vertical tongue riser 97 is welded to the end of tongue section 89 and to a second tongue section 111. This places the hitch 113 at an elevation that matches that of the towing vehicle's hitch ball.

The exhaust gas exiting engine 80 typically contains about 12% water vapor. A portion of this vapor condenses to liquid water as the gas cools during its passage through the tubular frame heat exchanger. If not removed, this condensate would accumulate and eventually impede the gas flow, in addition to causing rust to form inside the frame tubes. To correct this problem, a small amount of exhaust gas is preferably discharged continuously through a bleed hole (not shown) located at the lowest portion of the gas carrying portion of the tubular frame. The bleed gas entrains the condensate, thus preventing its accumulation.

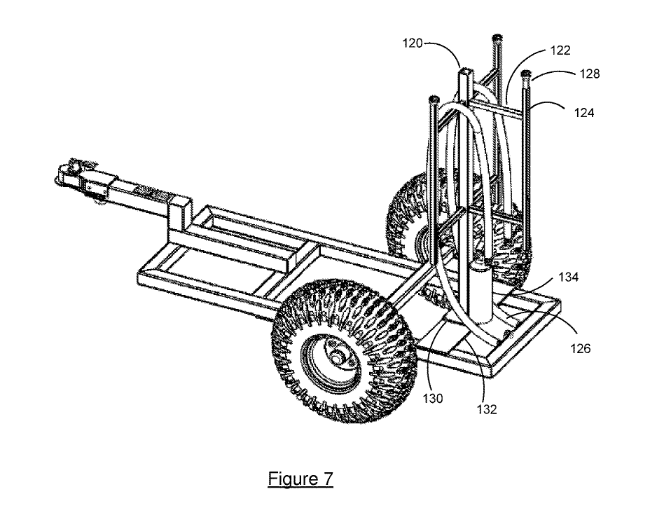

Two exemplary methods of stowing and deploying the hoses are now described. FIG. 7 shows a rack comprising a vertical tube 120 which is suitably 1.5 inches square by 40 inches high, along with six horizontal tubes typified by tube 122 and three vertical tubes typified by tube 124, all of which are suitably 0.75 inches square. For clarity, only two shortened hoses typified by hose 126 are shown. The inner dimension of tube 124 is preferably made greater than the outside diameter of a gas injector tube 128, thereby allowing up to three gas injector tubes to be stowed inside respective square tubes 124 when the trailer is under tow or parked. A 5.0 inch square base plate 130 allows the hose rack to be welded or bolted to a trailer hose support plate 132. A fire extinguisher 134 may be mounted on the lower portion of vertical tube 120.

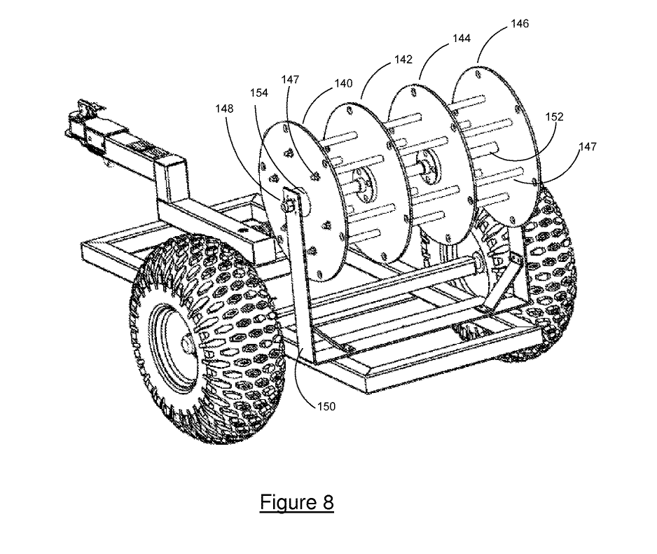

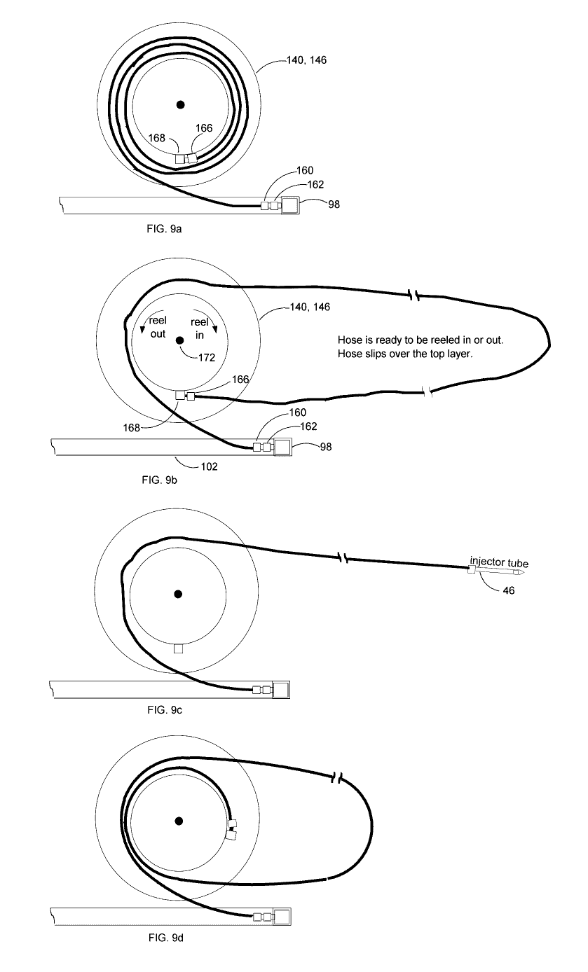

The hose rack described above and depicted in FIG. 7 is simple and low cost. However, some rodent control operators may object to the twisting of the hoses that takes place when the hoses are deployed or retrieved. A novel type of hose reel was developed to cope with this problem. Conventional hose reels are designed with compact rotatable couplings for use with for gas or liquids at a pressure exceeding 100 psi. A coupling pressure drop of several PSI has a negligible effect on the gas flow. The present system operates at a gas pressure of less than 10 psi. A standard hose reel with a few psi of pressure drop in the sliding gas transfer mechanism would greatly reduce the effectiveness of the present system. The new hose reel, described below and shown in FIG. 8, has no sliding gas transfer surfaces and the hoses are only disconnected from the trailer frame outlets when it becomes necessary to change hoses.

The hose reel consists of four identical PVC discs 140, 142 144 and 146 having a diameter of typically 16 inches. Six threaded rods 147 with nuts and washers on each end clamp together a total of 24 PVC pipes of the type used in the plumbing industry. These tubes, form the hubs of the three hose reel sections and also fix the horizontal distance between the PVC disks. A threaded steel rod 148 is attached to the hose reel support 150 with nuts and washers on each end. Steel rod 148 passes through a PVC pipe 152 (hidden in FIG. 8). The outer surface of the PVC pipe forms a rotatable bearing surface as it passes through a nylon bearing disc 154 with suitable clearance.

FIGS. 9a-9c show how the reel functions when deploying and retrieving the hose. One, two or three hoses may be simultaneously wound and unwound from the reel.

In FIG. 9a, the gas injector tubes have been removed and hoses have been manually wound up on the reel 140, 146. The hose inlet end 160 is connected to a hose bib 162 on the trailer rear frame tube 164, and the outlet end 166 is temporarily connected to a dummy hose fitting 168 that is loosely attached to one of the short PVC tubes that form the hose reel hub.

FIG. 9b shows the hoses unwound from the reel but with the hose outlet ends still connected to the dummy hose fittings on the hose reel hub. The operator has unwound the reel by grasping the hoses on the outer layer and then walking away from the machine as the three hoses slip through his/her fingers.

FIG. 9c shows the hose outlet ends disconnected from the dummy fittings and connected to the gas injector tubes 46. The operators proceed with gassing the rodent tunnels.

FIG. 9d shows the hoses partially reeled in. The operator accomplished this by grasping the rims of the reel 140, 146 and rotating the reel clockwise.

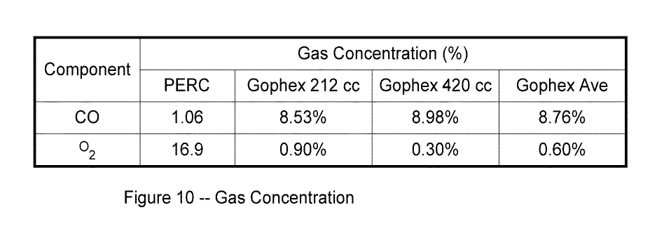

To demonstrate the improved performance of the present rodent eradication system, emission testing was performed on two embodiments of the present system, along with a prior art system (a PERC Model 206 from H & M Gopher Control). The prior art system employed a 206 cc 7 hp engine driving a 2 cylinder compressor via a V-belt and centrifugal clutch, and a dedicated heat exchanger. This was compared with an embodiment of the present system which included a 212 cc engine, and an embodiment with a 420 cc engine. The results are shown in the table of FIG. 10, which compares the concentrations of various gasses detected in the emissions of the three systems. As can be seen from the table, the average ratio of CO concentration for the two present systems (Gophex 212 cc and 420 cc) relative to the prior art system is 8.76/1.06=8.3. This high ratio indicates that the gas output of the present system embodiment is about 8 times as lethal as that of the prior art system. This improvement is partly due to the fact that the present system does not drive a mechanical load.

The high (16.9%) oxygen content of the prior art system's exhaust gas is caused by drawing ambient air into the compressor intake through the aforementioned tee fitting. High oxygen content eliminates the possibility of killing burrowing rodents by hypoxia.

When the present system includes an engine with more than one cylinder, the system can further include an exhaust manifold connected to receive gas exhausted from all of the exhaust ports and to provide the received gas at a single output. The input of the heat exchanger is then coupled to the single output. Such a system might also include one or more additional hoses coupled to the heat exchanger and one or more injector tubes coupled to respective ones of the additional hoses, such that the exhaust gas can pass through the gas outlets of multiple injector tubes simultaneously.

It may be advantageous to be able to determine if a tunnel into which exhaust gas is being pumped has become plugged. The present system might include a pressure measuring device coupled to an injector tube to measure the pressure in the subterranean tunnel, and thereby determine whether the tunnel has become plugged. Alternatively, the system might include a speed sensor coupled to the engine to detect a drop in engine speed and thereby determine whether the tunnel has become plugged.

The engine speed governor is preferably removed in the process of converting the engine to be a toxic gas generator. This permits higher engine speed which results in an increased gas production rate. Operating without a governor makes the engine speed dependent on exhaust back pressure. This allows the operator to detect a plugged tunnel by recognizing the change in pitch of the engine sound as speed decreases in response to the increased load caused by increased back pressure from a plugged tunnel. Alternatively, an electronic interface can be connected between the low voltage magneto coil and a sound transducer to create an audible tone with a frequency proportional to engine speed.

As described herein, the present rodent eradication system efficiently and economically produces and injects toxic gas into rodent tunnels, without the need for a compressor, clutch, V-belt, pressure tank and/or dedicated heat exchanger as is found in the prior art.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

I claim:

1. A system for eradicating burrowing rodents, comprising:
an engine which produces exhaust gas when operating;
a heat exchanger arranged to receive said exhaust gas at an input, to cool said exhaust gas as it passes through said heat exchanger, and to provide said cooled gas at an output;
a hose having first and second ends, said first end coupled to said heat exchanger output; and
an injector tube coupled to said second end of said hose and adapted for insertion into a subterranean tunnel in which a burrowing rodent may be present, said injector tube including gas outlets through which said exhaust gas can pass.

2. The system of claim 1, wherein said engine is an Otto cycle engine.

3. The system of claim 2, wherein said engine is a 4-stroke engine.

4. The system of claim 1, wherein said heat exchanger comprises aluminum or steel tubing.

5. The system of claim 1, wherein said heat exchanger is a gas-to-air heat exchanger.

6. The system of claim 1, wherein said engine is mounted over the wheels of a hand truck.

7. The system of claim 6, wherein said hand truck comprises:
a handle; and
tubing which runs between said engine and said handle to form the side, front and rear rails of said hand truck, said tubing comprising at least a portion of said heat exchanger.

8. The system of claim 6, wherein said heat exchanger comprises tubing, at least a portion of which comprises the side, front and rear rails of said hand truck.

9. The system of claim 1, wherein said engine is used solely to produce said exhaust gas.

10. The system of claim 1, wherein said hose comprises rubber.

11. The system of claim 10, wherein said hose is fiberglass reinforced nitrile rubber.

12. The system of claim 1, further comprising:
one or more additional hoses coupled to said heat exchanger; and
one or more injector tubes coupled to respective ones of said additional hoses, such that said exhaust gas can pass through the gas outlets of multiple injector tubes simultaneously.

13. The system of claim 1, wherein said engine has one or more cylinders.

14. The system of claim 1, wherein said engine has more than one cylinder and as many exhaust ports as cylinders, further comprising:
an exhaust manifold connected to receive gas exhausted from all of said exhaust ports and to provide said received gas at a single output, the input of said heat exchanger coupled to said single output.

15. The system of claim 14, further comprising:
one or more additional hoses coupled to said heat exchanger; and
one or more injector tubes coupled to respective ones of said additional hoses, such that said exhaust gas can pass through the gas outlets of multiple injector tubes simultaneously.

16. The system of claim 1, wherein said injector tube comprises carbon steel, stainless steel, brass or aluminum.

17. The system of claim 1, said injector tube further comprising a pointed metal fitting for penetrating the dirt over said subterranean tunnel when inserting said injector tube into said tunnel.

18. The system of claim 1, further comprising a tunnel probe for locating a subterranean tunnel, said tunnel probe comprising:
a steel or aluminum rod;
a pointed tip on one end of said rod; and
a wooden or plastic block on the other end of said rod.

19. The system of claim 1, further comprising a pressure measuring device coupled to said injector tube to measure the pressure in said subterranean tunnel and thereby determine whether said tunnel has become plugged.

20. The system of claim 1, further comprising a speed sensor coupled to said engine to monitor engine speed and thereby determine whether said tunnel has become plugged.

21. The system of claim 1, wherein said engine has a magneto coil, further comprising an electronic interface connected between said magneto coil and a sound transducer to create an audible tone with a frequency proportional to engine speed.

22. The system of claim 1, wherein said engine is mounted over the wheels of a towable trailer.

23. The system of claim 22, wherein said towable trailer comprises:
a trailer tongue coupled to said engine and which conveys exhaust gas from said engine; and
tubing which runs and conveys exhaust gas between said trailer tongue and one or more output fittings and which forms the tubular frame of said towable trailer, said tubing comprising at least a portion of said heat exchanger.

24. The system of claim 1, wherein said engine is used solely to produce said exhaust gas and the spark advance angle has been retarded with respect to normal ignition timing for said engine.

25. The system of claim 24, wherein the throttle opening of said engine's carburetor is increased as needed to restore engine speed lost by retarding said spark advance angle.

26. The system of claim 1, wherein said spark advance angle has been retarded to give a net advance angle of 20°.

27. The system of claim 1, wherein said engine is arranged to produce pulsating pressurized exhaust gas from an exhaust port.

28. The system of claim 1, further comprising a bleed hole located at the lowest portion of the gas carrying portion of said heat exchanger through which exhaust gas can bleed, said bleed gas entraining condensate that might otherwise accumulate in said heat exchanger.

29. The system of claim 1, wherein said engine has no governor.

30. The system of claim 1, further comprising a hose reel on which said hose is wound when not used, said hose reel comprising a hub which includes at least one dummy hose fitting, said hose coupled to said heat exchanger output at said first end and to said dummy hose fitting at said second end when unused, said hose reel having no sliding gas transfer surfaces.

31. A method of eradicating burrowing rodents from a subterranean tunnel, comprising:
generating exhaust gas using an engine;
cooling said exhaust gas; and
injecting said cooled exhaust gas into a subterranean tunnel in which a burrowing rodent may be present.

32. The method of claim 31, wherein said engine has more than one cylinder, further comprising:
cooling said exhaust gas produced by each of said cylinders; and
injecting said cooled exhaust gas into multiple subterranean tunnels simultaneously.

33. The method of claim 32, further comprising:
collecting the exhaust gas produced by all of said cylinders into a common manifold.

34. The method of 31, further comprising retarding the spark advance angle with respect to normal ignition timing for said engine.

35. The method of claim 34, wherein the throttle opening of said engine's carburetor is increased as needed to restore engine speed lost by retarding said spark advance angle.

36. The method of claim 31, further comprising:
probing the ground to locate a subterranean tunnel prior to injecting said cooled exhaust gas into said subterranean tunnel.

37. The method of claim 31, further comprising monitoring the pressure in said subterranean tunnel to determine if said tunnel has become plugged.

38. The method of claim 31, further comprising monitoring the speed of said engine to detect when said subterranean tunnel has become plugged.

39. The method of claim 31, further comprising creating an audible tone with a frequency proportional to engine speed to detect when said subterranean tunnel has become plugged.
